(19) United States
(12) Patent Application Publication
(10) Pub. No.: US 2025/0100080 A1
(43) Pub. Date: Mar. 27, 2025

(54) METHOD FOR MACHINING A WORKPIECE BY LASER AND LASER MACHINING DEVICE FOR PERFORMING THE METHOD

(71) Applicant: ROLLOMATIC S.A., Le Landeron (CH)

(72) Inventors: Christian KRUMM, Cottebert (CH); Mouhamadali Freidy, Renens (CH); Fernando Manuel Da Silva Ribeiro, Diesse (CH)

(21) Appl. No.: 18/914,079

(22) Filed: Oct. 12, 2024

Related U.S. Application Data
(63) Continuation of application No. PCT/EP2023/060457, filed on Apr. 21, 2023.

(30) Foreign Application Priority Data
Apr. 21, 2022 (EP) 22169347.6

(51) Int. Cl. B23K 26/36; B23K 26/08; B23K 26/082

(52) U.S. Cl. CPC B23K 26/36; B23K 26/082; B23K 26/0823; B23K 26/083

(57) ABSTRACT

A method and a device for laser machining a workpiece, wherein a predetermined outer workpiece shape with a contour is produced on the workpiece by removing material using a laser beam from a laser machining device that includes a workpiece fixing device, which receives and fixes the workpiece, a movement device, which moves the workpiece fixing device relative to a device base, and a laser, which generates a laser beam directed along a beam axis, and a laser deflection device that deflects the laser beam in a controlled manner. A movement of the workpiece, a guidance of the laser beam, and an advancing movement of the workpiece and/or the laser beam are performed out in a synchronized manner when performing the method.

### RELATED APPLICATIONS

This application is a continuation of international application PCT/EP2023/060457 filed on Apr. 21, 2023 claiming priority from European patent application EP 22 16 93 47.6 filed on Apr. 21, 2022, both of which are incorporated in their entirety by this reference.

### FIELD OF THE INVENTION

The invention relates to a method for laser machining a workpiece.

Machining of workpieces by short intense laser pulses is known in the art. Laser radiation with high power density causes a heating of a material at a surface of the workpiece. The surface of the workpiece locally reaches a temperature that is high enough for the material of the workpiece to evaporate or sublimate. The high-power density of the laser generate a plasma from electrons and ions of the removed material. The material removal is also designated as laser ablation or laser evaporation. Thus, the material can be removed in surface layers. There is also the option to cut a workpiece by continuous or pulsed laser radiation. This is designated as laser cutting or laser beam cutting. The parameters of the laser radiation have to be adapted to the material to be machined and the desired type of machining. Parameters of the laser radiation are wave length and average power. In case the laser radiation is pulsed, pulse energy and pulse duration are among the parameters. The laser beam and the workpiece are arranged relative to one another in a defined manner and moved as needed in order to remove the material within predetermined portions of the workpiece in a controlled manner and to form particular workpiece contours at the surface of the workpiece. This includes generating cutting edges or other edges at workpieces.

A laser machining device includes a laser that generates a laser beam. A laser beam extends along a beam axis. Thus, the beam axis corresponds to a geometric straight line. The laser includes a laser head which orients the laser beam and the laser beam axis onto a workpiece in a controlled manner and moves the laser beam along the surface of the workpiece within a predetermined workpiece contour. The workpiece is arranged in an alignment and positioning device which is also designated as a clamping device in a machine tool. The clamping device includes a clamping device base, a workpiece fixing device and a movement device. The clamping device base is fixed in place. The clamping device base can be part of a machine base of the laser machining device. The workpiece fixing device receives the workpiece and clamps the workpiece so that the position of the workpiece relative to the workpiece fixing device does not change during the machining of the workpiece. The movement device causes a movement of the workpiece fixing device relative to the device base. Since the laser head of the laser machining device is typically fixed in place relative to the device base the movement device also causes a relative movement between the laser head and the workpiece fixing device. Accordingly, this moves a workpiece clamped at the workpiece fixing device relative to a laser beam generated by the laser head. Due to the relative movement caused by the movement device an entire surface of the workpiece can be machined as long as the workpiece surface is not covered by the workpiece fixing device. The workpiece and the workpiece surface are oriented at different angles relative to the laser beam during machining. The laser head can include a laser deflection device that deflects the laser beam in a controlled manner through optical components so that the laser beam is guided over a surface of the workpiece with high velocity. This deflection device causes an additional relative movement of laser beam and workpiece. The velocity at which a laser beam is moved by the laser beam deflection device is typically greater than the velocity of the workpiece being moved relative to the clamping device base by the movement device.

In order to machine the workpiece the laser beam is typically oriented with its beam axis relative to the workpiece to be machined so that the beam axis is oriented perpendicular to the surface of the workpiece. Subsequently the material is removed from the surface of the workpiece in layers until the workpiece has the desired workpiece shape. This method is only suitable for machining small portions of a workpiece since removing the material in layers is very time consuming. A method that removes material in layers is unsuitable for machining a workpiece along its entire enveloping surface, in particular to produce an outer workpiece contour of a workpiece extending over an entire circumference for time and cost reasons. This applies in particular when producing a drill or a reamer from a cylindrical blank.

### BRIEF SUMMARY OF THE INVENTION

It is an object of the invention to provide a method and a device for machining a workpiece by laser that facilitates producing a workpiece with a predetermined outer workpiece contour from a blank with high precision wherein the workpiece contour extends over an entire circumference at least in one axial section, and wherein the workpiece remains clamped in a workpiece fixing device during the entire machining process so that reclamping the workpiece can be omitted.

The object is achieved by a method with the features of claim 1 and by a laser machining device with the features of claim 17. The elongated workpiece to be produced extends along a geometric workpiece longitudinal axis. A predetermined three-dimensional outer workpiece shape is produced with a workpiece contour at the workpiece by removing material by the laser beam. Thus, the workpiece contour corresponds to an intersection of the three-dimensional outer workpiece shape to be produced with a geometric workpiece plane in which the geometric workpiece longitudinal axis extends. The workpiece contour extends between a first point A and a second point B, wherein the points A and B are offset from one another at least in an axial direction. The method according to claim 1 is characterized in that the workpiece is arranged in a workpiece fixing device of a laser machining arrangement and that three super imposed movements can be performed simultaneously wherein the movements cause a controlled material removal at the workpiece.

A first movement is a workpiece rotation movement where the workpiece fixing arrangement rotates the workpiece about the geometric workpiece longitudinal axis. This rotation is endless. Thus, the workpiece performs a continuous sequence of complete rotations. Since the workpiece rotates about the geometric workpiece longitudinal axis the rotation is performed about a rotation axis that is fixed relative to the workpiece. The second movement is caused by controlled orientation of the laser beam, thus the laser beam is moved along a predetermined laser path by the laser deflection device. This laser path corresponds to the workpiece contour of the predetermined three-dimensional workpiece shape between the point A and the point B. When orienting the laser beam, the laser beam is oriented perpendicular relative to the geometric workpiece plane or encloses on angle of ten degrees at the most with an orthogonal or the workpiece plane. An orthogonal is a straight line that is perpendicular to the workpiece plane. The laser beam is run along the laser path between A and B during the second movement several times.

A third movement is a feed movement where the workpiece fixing device and/or the laser beam are advanced so that the surface of the workpiece arranged in the workpiece fixing device contacts the laser beam so that the laser beam is oriented tangential to the surface of the workpiece or encloses an angle of ten degrees at the most with the tangent to the surface of the workpiece. Thus the laser beam removes material from the surface of the workpiece and generates the predetermined three-dimensional outer workpiece shape with the workpiece contour.

The three movements are superimposed timewise. The first movement, the second movement and the third movement are performed simultaneously and parallel to one another until the predetermined workpiece contour is generated at the workpiece.

Since the workpiece is rotated continuously while the laser beam removes material at the outside of the workpiece the material removal is performed at an entire outer circumference of the workpiece at least in the axial section of the workpiece that extends between the two points A and B similar to a lathe.

Thus, the material is not removed in layers but entire portions are removed along the circumference of the workpiece. The first movement is a sequence of complete revolutions of the workpiece about the geometric workpiece longitudinal axis. The second movement can be repeated at will. Thus the laser beam is moved back and forth several times along the laser beam path between the first point A and the second point B. The third movement provides that the rotated workpiece and the laser beam run along the laser path come into contact so that material is removed from the outside of the workpiece in a controlled manner by the laser beam.

The workpiece contour of the workpiece is predetermined by the outer workpiece shape that is to be generated. The workpiece contour corresponds to a curve that delimits the workpiece configured with the workpiece shape to be generated from its ambient in the portion to be machined by the method.

The predetermined three-dimensional outer workpiece shape can have different cross sections in the axial section between the two points A and B. This has the effect that the workpiece contour has different distances from the geometric workpiece longitudinal axis between the points A and B.

The two points A and B are offset from one another in the axial direction along the geometric workpiece longitudinal axis. Additionally, they can also be offset from one another in the radial direction.

The laser beam is oriented relative to the workpiece during the second movement so that a beam axis of the laser beam is oriented perpendicular to the geometric workpiece plane that includes the geometric workpiece longitudinal axis or that encloses an angle of ten degrees at the most with the geometric workpiece plane.

The laser path corresponds to an intersection between the geometric workpiece plane and the three-dimensional outer workpiece shape to be generated. The intersection extends in the workpiece plane on both sides of the geometric workpiece longitudinal axis. The intersection is oriented axially symmetrical to the geometric workpiece longitudinal axis for rotation symmetrical shapes of the workpiece. The laser path can extend exclusively on one side of the workpiece longitudinal axis or on both sides of the workpiece longitudinal axis.

The first movement, the second movement and the third movement are adapted to one another so that any outer workpiece shape of the workpiece can be generated. These workpiece shapes include rotation symmetrical workpiece shapes and non-rotational rotation symmetrical workpiece shapes, e.g. outer workpiece shapes that include flat surfaces.

The method according to the invention facilitates generating an external workpiece shape of the workpiece that extends over an entire outer circumference of the workpiece and that extends in axial direction along the workpiece longitudinal axis. The workpiece remains clamped in the workpiece fixing device during machining. The machining is quick and precise.

It is an essential advantage of the method according to the invention that a focus of a focused laser beam is continuously arranged at a position to be machined or closely proximal to this position during laser machining. This facilitates optimum machining of the workpiece.

According to an advantageous embodiment of the invention the laser beam is run along the laser path from A to B and thereafter from B to A. This movement can be repeated at will until the predetermined workpiece shape is generated at the workpiece.

According to another advantageous embodiment of the invention the laser beam is moved from A to B several times wherein the movement of the active laser beam is exclusively performed in the direction from A to B and not the other way around. In order to return the laser beam to point A after reaching point B the laser beam is either turned off during the return or the return is performed along a curve when the laser beam is activated wherein the curve differs from the laser path A-B defined by the workpiece contour of the workpiece to be generated, and wherein this return curve is outside of the workpiece to be generated in order to prevent an undesirable interference between the laser beam and the workpiece.

According to another advantageous embodiment of the invention the laser beam is moved essentially perpendicular to the beam axis of the laser beam during the second movement along the laser path from A to B. Thus, the movement direction of the laser beam is essentially perpendicular to the beam axis of the laser beam during the second movement.

According to another advantageous embodiment of the invention the first point A and the second point B represent boundaries of the three-dimensional outer workpiece shape be generated in the axial direction with reference to the workpiece longitudinal axis. The laser machining is performed in an area that extends in the axial direction between the boundaries of the points A and B.

According to another advantageous embodiment of the invention the laser beam additionally performs a fourth movement where the laser beam is moved in open or closed curves about a center. Thus, the fourth movement is superimposed to the second movement. The center of the fourth movement is on the contour that is predetermined by the workpiece contour to be generated. Thus, a diameter of the laser beam can be incorporated as an offset. Thus, the laser beam is moved along the workpiece contour to be generated from the first point A to the second point B according to the second movement and moved according to the fourth movement along small closed or open curves simultaneously. The laser beam is not only run in a straight, curved or irregular line that corresponds to the workpiece contour to be generated but performs a loop movement about the workpiece contour to be generated when performing the fourth movement. Thus, the portion where the laser beam impinges the workpiece and removes material from the workpiece is enlarged. Thus, the size of the open or closed curves is small compared to the workpiece contour to be generated. The closed curves can be circles, ellipses or figure eight shapes. Open curves are characterized in that a starting point and an end point of the curve do not coincide.

According to another advantageous embodiment of the invention a ratio between the diameter of the opened or closed curve and a diameter of the laser beam during impingement at the workpiece is between 1.2 and 150. This assures that a size of the open or closed curves is small compared to the workpiece contour to be generated. The curve advantageously has a diameter between 0.05 mm and 2.0 mm. The diameter of the laser beam when impinging the workpiece is between 0.008 mm and 0.03 mm, particularly advantageously between 0.15 mm and 0.03 mm.

According to another advantageous embodiment of the invention the workpiece fixing device is moved in a direction perpendicular to the beam axis of the laser beam while performing the third movement.

According to another advantageous embodiment of the invention the workpiece fixing device is moved perpendicular to the workpiece longitudinal axis when performing the third movement.

According to another advantageous embodiment of the invention the laser beam is moved in a direction of the geometric workpiece longitudinal axis while performing the third movement.

According to another advantageous embodiment of the invention the third movement includes a linear movement in a radial direction relative to the workpiece longitudinal axis.

According to another advantageous embodiment of the invention the third movement includes a linear movement in the axial direction or parallel to the axial direction of the workpiece longitudinal workpiece axis. The third movement can include a super position of a radial movement and an axial movement with respect to the workpiece longitudinal workpiece axis.

According to another advantageous embodiment of the invention a beam axis of the laser beam is oriented parallel to a radial direction with reference to the geometric workpiece longitudinal axis when removing material from the surface of the workpiece. The feed movement of the third movement causes the focus of the laser beam to be either at the surface of the workpiece, on the workpiece contour to be generated, or proximal thereto.

According to another advantageous embodiment of the invention a beam axis of the laser beam is inclined by an angle α relative to a tangent at the surface of the workpiece shape to be generated when the angle α is between 1 degree and 10 degrees. Thus the inclination about the angle α relative to the tangent can be arranged in any direction. The tangent at the surface defines a plane together with the beam axis. This plane can be e.g. perpendicular to the geometric workpiece longitudinal axis or parallel to the geometric workpiece longitudinal axis. Additionally, the plane can have any other orientation relative to the geometric workpiece longitudinal workpiece axis.

According to another advantageous embodiment of the invention the third movement is controlled as a function of the second movement.

According to another advantageous embodiment of the invention the third movement is controlled as a function of the first movement.

According to another advantageous embodiment of the invention material is removed along an entire circumference of the workpiece in the axial section between the points A and B.

According to another advantageous embodiment of the invention the workpiece is rotated at constant speed during the entire material removal. Alternatively, the rotation speed can be adjusted as a function of the second movement and the third movement and/or as a function of the external workpiece contour to be generated.

According to another advantageous embodiment of the invention the workpiece arranged in the workpiece fixing device is rotated at a speed between 5 rpm and 1,000 rpm. Thus, the speed of rotation can remain constant during the entire processing or vary as a function of the workpiece and/or the workpiece shape to be generated. A constant speed of rotation between 50 and 300 rpm can be set e.g. for a rotation symmetrical workpiece. This, however, is not mandatory. The speed of rotation can be adapted to a workpiece diameter. For a rotation symmetrical diameter of the workpiece the speed of rotation can be lower initially as long as the laser beam does not contact the surface of the workpiece. However, as soon as the laser beam approaches the surface of the workpiece the speed of rotation can be increased. This influences an amount of material that is removed from the surface of the workpiece. Thus, a change and adaptation of the speed of rotation can facilitate that identical amounts of material are removed in predetermined time intervals though a diameter of the workpiece changes due to the material removal.

According to another advantageous embodiment of the invention the laser beam is moved at a velocity between 0.05 m/sec and 10 m/sec during the second movement which changes the orientation of the laser beam.

According to another advantageous embodiment of the invention the third movement where the workpiece fixing device and/or the laser beam are moved towards each other is performed at a velocity between 0.05 mm/min and 500 mm/min.

According to another advantageous embodiment of the invention a direction of rotation of the workpiece fixing device is adjusted during laser machining of the workpiece.

The laser machining device for performing the method according to the invention is characterized in that it includes a workpiece fixing device that receives the workpiece, a movement device that moves the workpiece fixing device relative to a device base and includes a laser which generates a laser beam oriented along a laser beam axis and which includes a laser beam deflection device that deflects the laser beam in a controlled manner. Thus, the movement device is configured to perform a workpiece rotation movement of a workpiece arranged in the workpiece fixing device. This movement is designated as the first movement. The laser deflection device is configured to guide the laser beam and to move the laser beam along a predetermined laser path wherein the laser path runs from a first point A to a second point B and wherein the laser path is predetermined by the workpiece contour to be generated. This movement is designated as the second movement. The movement device and/or the laser perform a feed movement so that the surface of the workpiece arranged in the workpiece fixing device contacts the laser beam, wherein the laser beam removes material from the surface of the workpiece and generates the predetermined outer workpiece contour. The feed movement is designated as the third movement. Thus, the laser machining device is configured so that the first movement, the second movement and the third movement are performed simultaneously adapted to one another.

According to another advantageous embodiment of the invention the laser machining device includes a control device which controls the first movement, the second movement, and the third movement. This assures that the three movements are adapted to each other. When the laser beam performs an additional fourth movement, the control device advantageously also controls the fourth movement.

Additional advantages and advantageous embodiments of the invention can be derived from the subsequent description, the drawing figure and patent claims.

### BRIEF DESCRIPTION OF THE DRAWINGS

Advantageous embodiments of machining a workpiece by a laser according to the invention are now described with reference to drawing figures, wherein:

FIG. 1 illustrates a first embodiment of laser machining a workpiece;

FIG. 2 illustrates the workpiece according to FIG. 1 at a beginning of the machining;

FIG. 3 illustrates the workpiece according to FIG. 1 at different points in time of the machining;

FIG. 4 illustrates an orientation of the laser beam during machining according to FIGS. 1-3 and a movement direction of the third movement;

FIG. 5 illustrates an alternative orientation of the laser beam during machining according to FIGS. 1-3 and a representation of the movement direction of the third movement;

FIG. 6 illustrates an orientation of the laser beam during machining according to FIG. 4 and a representation of an alternative movement direction of the third movement;

FIG. 7 illustrates the second and the fourth movement of the laser beam;

FIG. 8 illustrates the second and alternative fourth movement of the laser beam;

FIG. 9A illustrates a perspective view of the workpiece in an early condition of the laser machining;

FIG. 9B illustrates the condition according to FIG. 9A in a front view;

FIG. 10A illustrates the workpiece in a perspective view at an end laser machining;

FIG. 10B illustrates the workpiece in the condition according to FIG. 10A in a front view;

FIG. 11 illustrates the workpiece in a perspective view and in a front view at different points in time of the laser machining;

FIG. 12 illustrates the workpiece, wherein the laser beam is arranged at different positions along the laser path;

FIG. 13 illustrates a second embodiment of the laser machining of a workpiece;

FIGS. 13A through 13N illustrates the workpiece and the laser beam according to the second embodiment at different points in time of the laser machining;

FIG. 14 illustrates laser machining of a workpiece not performed according to the invention;

FIG. 15 illustrates the workpiece according to FIG. 14 before the laser machining begins;

FIG. 16 illustrates the workpiece according to FIG. 14 at the beginning of the laser machining;

FIG. 17 illustrates the workpiece according to FIG. 14 during the laser machining;

FIG. 18 illustrates the workpiece according to FIG. 14 after the laser machining is completed; and

FIG. 19 illustrates the laser machining device in a perspective view.

### DETAILED DESCRIPTION

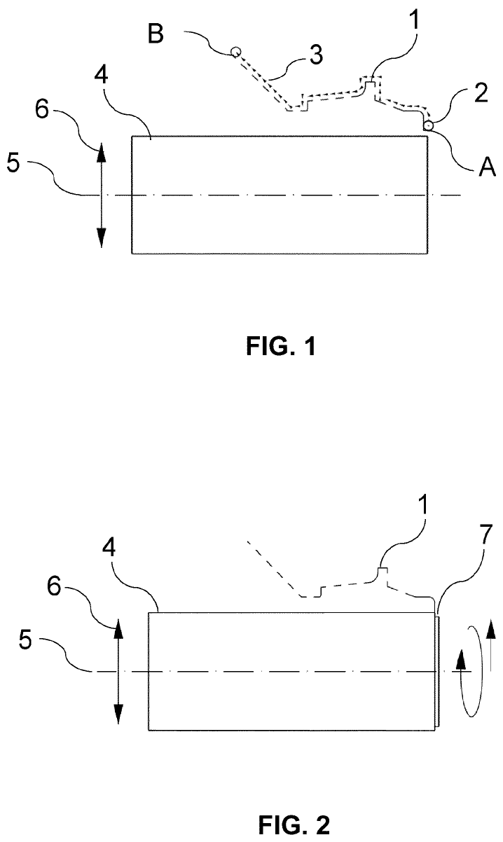

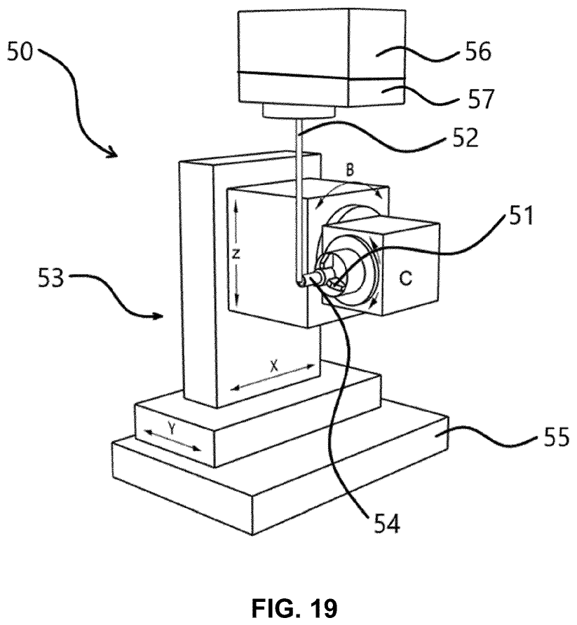

FIGS. 1-12 illustrate a first method of laser machining a workpiece 4 by a laser beam 2. A workpiece 4 is initially provided as a blank. The blank is provided as a circular cylinder. The workpiece 4 is clamped in a workpiece fixing device of a laser machining device. The laser machining device 50 is shown with a workpiece fixing device 51, a movement device 53 and a laser 56 in FIG. 19. The movement device facilitates a movement of the workpiece fixing device relative to a device base 55. The movement includes a rotation of the workpiece fixing device 51 together with the workpiece 4 or 54 received in the workpiece fixing device 51 about a geometric axis that coincides with the geometric workpiece longitudinal axis 5. The workpiece longitudinal workpiece 5 thus runs through the workpiece 4. The workpiece longitudinal axis is fixed relative to the workpiece. In the instant embodiment the workpiece 4 has a shape of a circular cylinder before the laser machining. The circular cylinder is a rotation symmetrical with respect to the geometric workpiece longitudinal axis 5. The workpiece 4 performs a continuous sequence of complete rotations when rotating about the workpiece longitudinal axis 5. This movement is designated as the first movement. This movement is indicated by a circular arrow adjacent to the workpiece 4 in FIGS. 2-6.

The laser machining is configured to generate an outer workpiece shape with the workpiece contour 1 at the workpiece. In the embodiment according to FIGS. 1-12 the workpiece shape to be generated is rotation symmetrical with respect to the geometric workpiece longitudinal axis 5.

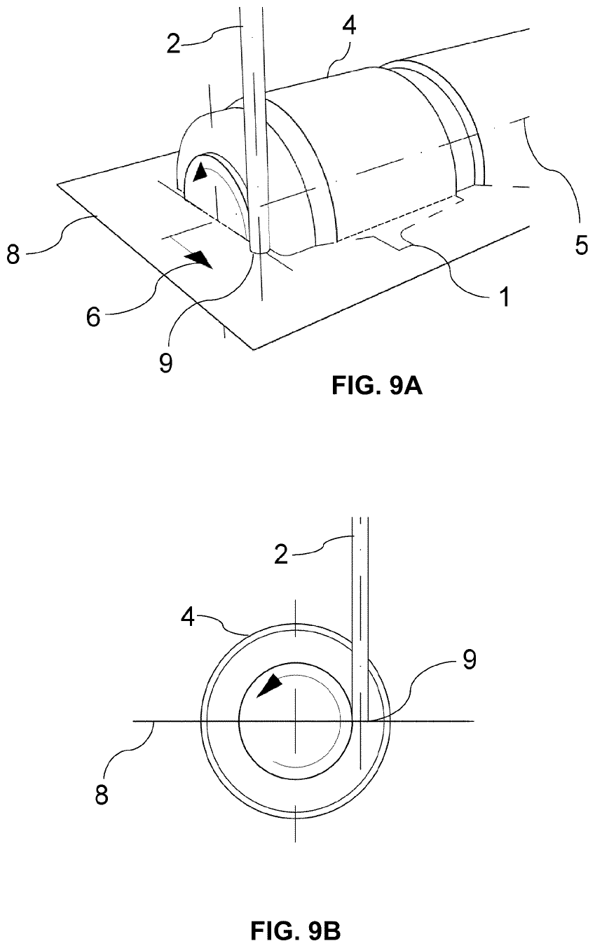

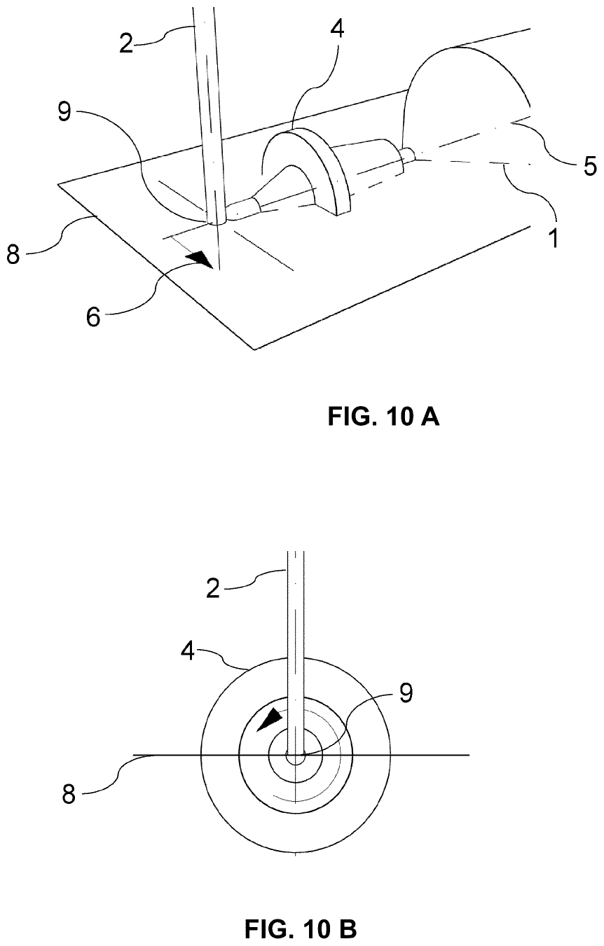

The laser beam 2 with the geometric beam axis 2a is generated by the laser 56 shown in FIG. 19 that is run along the workpiece contour 1 by a laser deflection device illustrated in FIG. 19. This movement of the laser beam is designated as the second movement. The laser path 3 is predetermined by the workpiece contour 1 and runs from a first point A to a second point B. The offset between the workpiece contour 1 and the laser path 3 is due to a radius of the laser beam 2 in a geometric workpiece plane 8 illustrated in FIGS. 9A, 9B, 10A, and 10B. This view considers that the laser beam 2 does not only remove material from the workpiece 4 in a point in a center of the laser beam but removes material in a circular area.

During laser machining the laser beam 2 is run along the laser path between points A and B several times until enough material is removed from the workpiece 4 by the laser beam 2 so that the predetermined outer workpiece shape is generated. Thus, the laser beam can be moved back and forth between the points A and B or the laser beam can only be run in one direction from A to B or from B to A. A number of cycles, this means how many times the laser beam 2 is to be run through the laser path 3 is a function of a type and amount of the material to be removed and also depends on the laser.

Advantageously the laser is a pulsed laser. The short laser pulses generate a high energy density at the surface of the workpiece without introducing an undesirable amount of heat into the workpiece. The duration of the laser pulses is advantageously in a piko second or femto second range.

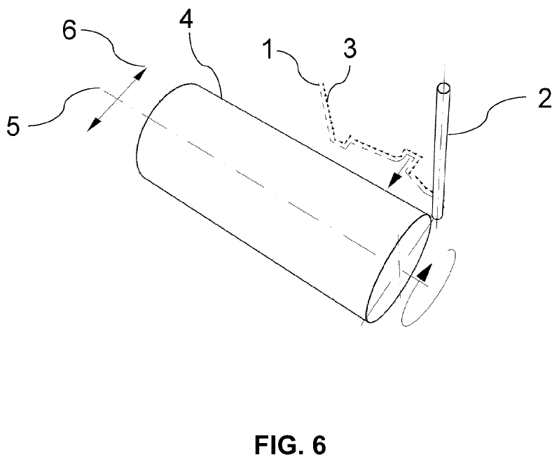

Due to a feed movement that advances the workpiece fixing device and/or the laser beam, the surface of the workpiece 4 arranged in the workpiece fixing device comes in contact with the laser beam 2, wherein the laser beam 2 removes material from the surface of the workpiece 4 and generates the workpiece contour 1 step by step. The feed movement is designated as the third movement. FIGS. 1-6 show the feed movement as a linear movement of the workpiece 4 perpendicular to the geometric workpiece longitudinal axis 5 with the movement direction 6. FIG. 6 shows additionally that the laser path 3 is moved in a direction of the geometric workpiece longitudinal axis 5. This is a parallel displacement of the laser path 3 in a direction designated by the arrow.

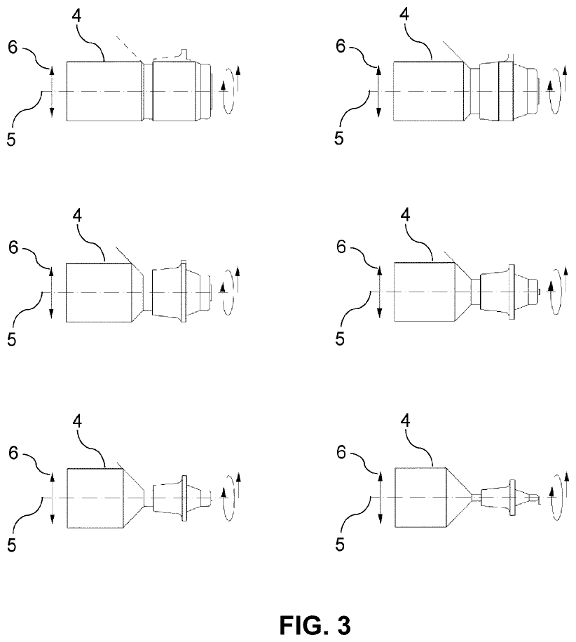

The first movement, the second movement and the third movement are being performed simultaneously and they are superimposed to each other. Thus, the laser beam 2 removes material from the surface of the workpiece 4, wherein the predetermined workpiece shape of the workpiece 4 is generated step by step. This is illustrated in FIG. 3. In the first embodiment the laser beam 2 illustrated in FIGS. 1, 4, 5, and 6 initially impacts the contact point 7 at the workpiece 4 illustrated in FIG. 2. This contact point 7 coincides with the first point A of the laser path 3.

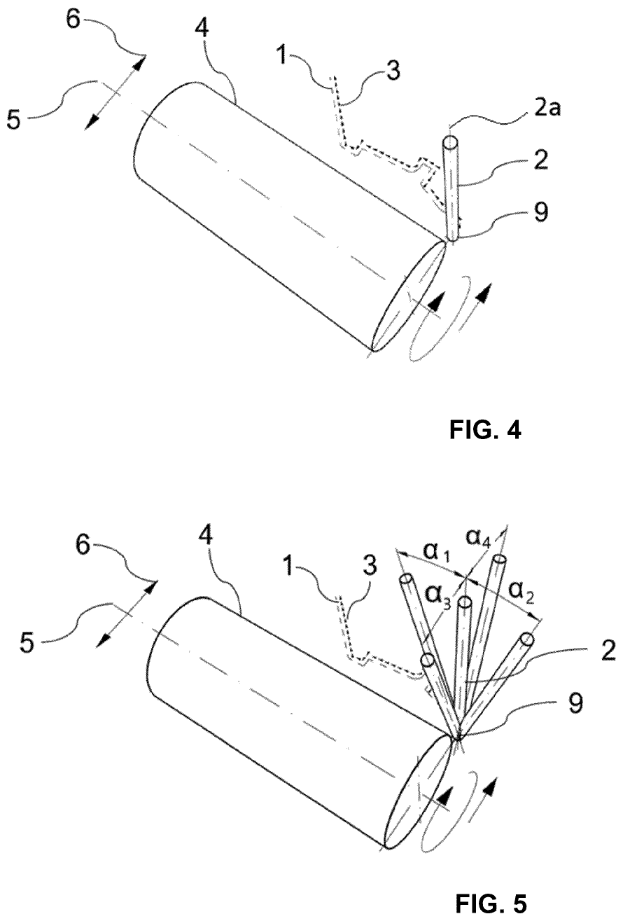

A beam axis 2a of the laser beam 2 can be oriented perpendicular to a workpiece plane 8. The workpiece plane 8 is a geometric plane that runs through the workpiece 4. The geometric workpiece longitudinal axis 5 runs in the workpiece plane. The workpiece plane 8 is illustrated in FIGS. 9A, 9B, 10A, and 10B. As a matter of principle, there is an infinite number of workpiece planes that run through the workpiece 4 and that include the workpiece longitudinal axis 5. All these planes that fulfill this condition intersect in the workpiece longitudinal axis 5. The workpiece plane 8 illustrated in FIGS. 9A, 9B, 10A, and 10B are in particular oriented perpendicular to the laser beam 2. This perpendicular orientation of the laser beam 2 is shown in FIGS. 4, 6, 9A, 9B, 10A, 10B. When the laser beam 2 is oriented perpendicular to the workpiece plane 8, the laser beam 2 runs tangential to the surface of the workpiece when the material is removed. Alternatively, the laser beam 2 can be tilted by an angle α from this perpendicular orientation. A straight line perpendicular to the workpiece plane 8 is also designated as an orthogonal. The beam axis 2a of the laser beam 2 either runs perpendicular to the workpiece plane 8 or encloses an angle of 10 degrees at the most with an orthogonal of the workpiece plane 8. The laser beam 2 and the workpiece 4 are brought in contact with one another so that the laser beam 2 is oriented tangential to the surface of the rotating workpiece or encloses an angle of 10 degrees at the most with the tangent of the workpiece surface. This is illustrated in FIG. 5. This illustration shows that the beam axis 2a of the laser beam 2 can be oriented in various directions relative to a tangent at the workpiece surface in the point that is to be machined. The laser focus 9 is advantageously arranged at or proximal to the surface of the workpiece 4. FIG. 5 shows four exemplary directions in which the laser beam can be inclined with its beam axis. When the angles are α₁ and α₂ the beam axis of the laser beam 2 and the tangent at the point to be machined run at the surface of the workpiece 4 in a plane that is parallel to the workpiece longitudinal axis 5. The beam axis of the laser beam 2 and the tangent at the point to be machined run in a plane at the surface of the work piece 4 at the angles α₃, α₄, wherein the plane is perpendicular to the work piece longitudinal axis 5. The inclination of the laser beam by an angle α, however, can be oriented in any other direction. The angles α, α₁, α₂, α₃, α₄, α₅ between the beam axis of the laser beam 2 and the tangent at the work piece shape of the work piece to be generated are between 1 degree and 10 degrees.

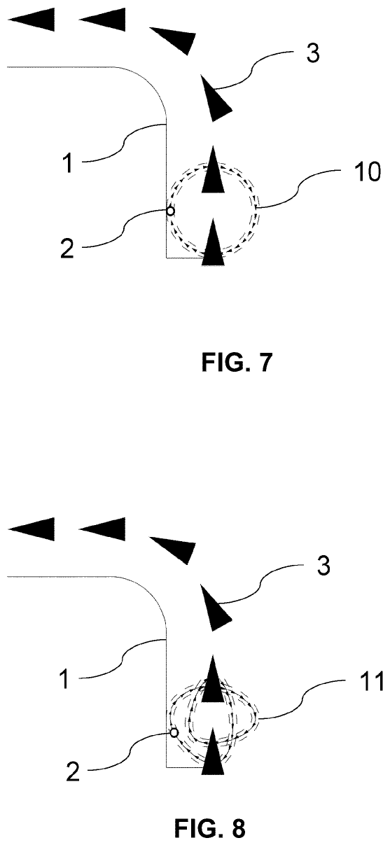

FIGS. 7 and 8 show an additional movement of the laser beam 2, this movement is designated as the fourth movement. The laser beam 2 running along the laser path 3 is additionally moved along closed circular curves 10 or along irregular curves 11.

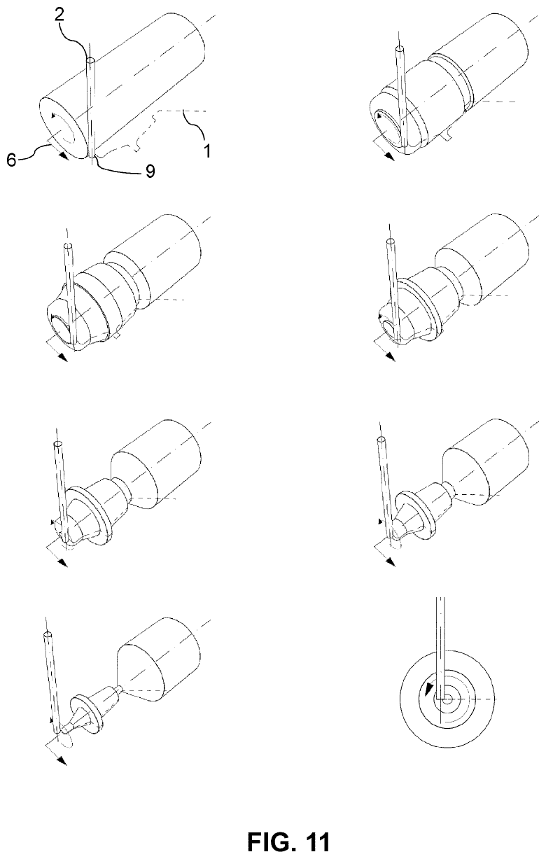

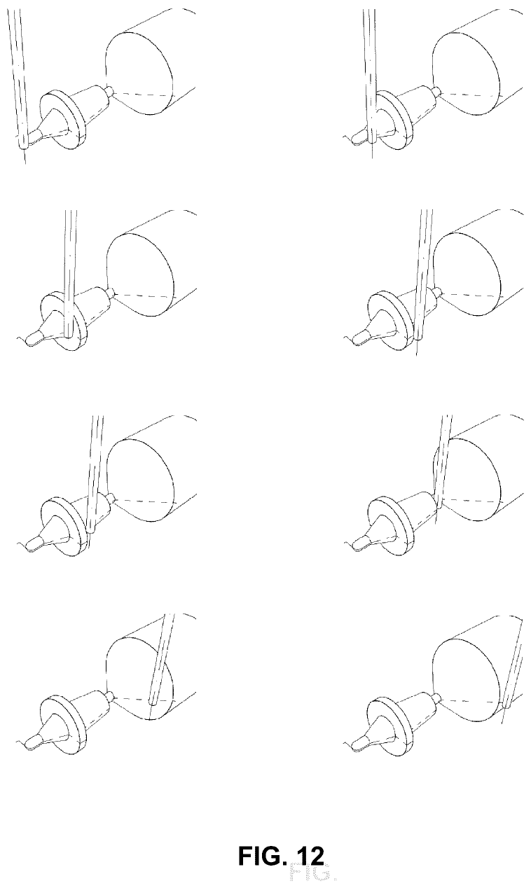

FIGS. 9A and 9B, 10A and 10B, 11 and 12 show the work piece 4 and the laser beam 2 in various views at different points in time of the laser machining. These figures show that the focus 9 of the laser beam 2 is arranged directly at the surface of the work piece 4. FIG. 11 additionally shows the work piece 4 in various stages of laser machining. FIG. 12 shows how the laser beam 2 is run relative to the work piece 4 during the second movement and how the laser beam moves along the predetermined laser path 3. The first representation in FIG. 12 shows the laser beam 2 in the first point A. The last representation in FIG. 12 shows the laser beam 2 in the second point B. The laser machining is complete in the last representation in FIG. 12. Now the work piece has the nominal three-dimensional external work piece shape. The nominal external work piece shape is additionally shown in FIG. 10A and in the second to last representation of FIG. 11. The predetermined outer work piece shape includes different cross sections in various axial sections. Thus, the predetermined outer work piece shape is rotation symmetrical overall. The remaining representations in FIG. 12 show the laser beam 2 at positions on the laser path 3 between the points A and B.

FIGS. 9A and 10A show the laser path 3 as an intersection between a geometric work piece plane 8 and an outer work piece shape to be generated.

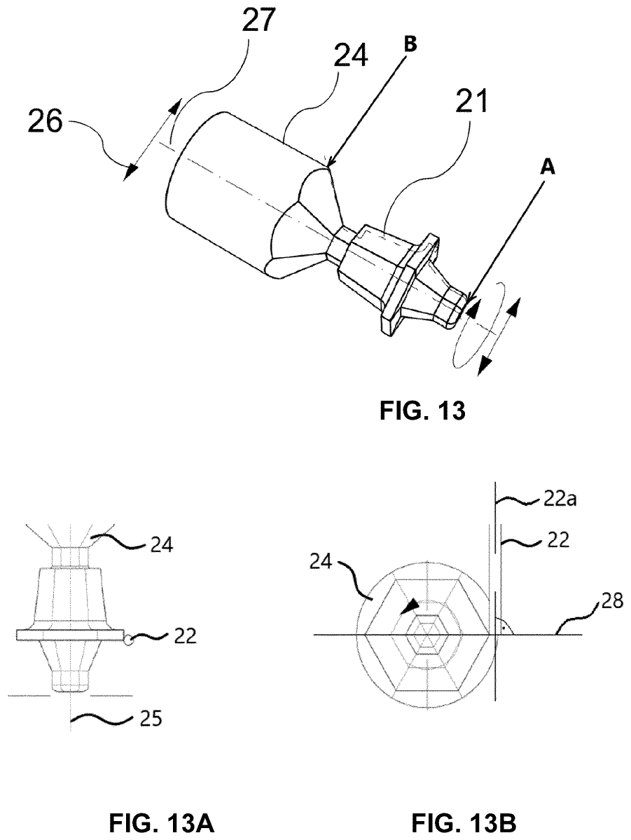

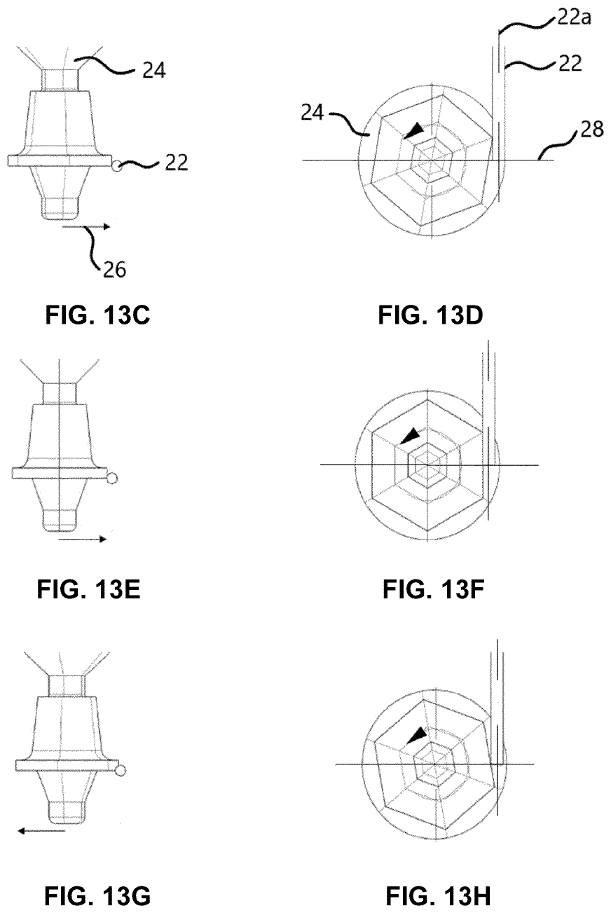

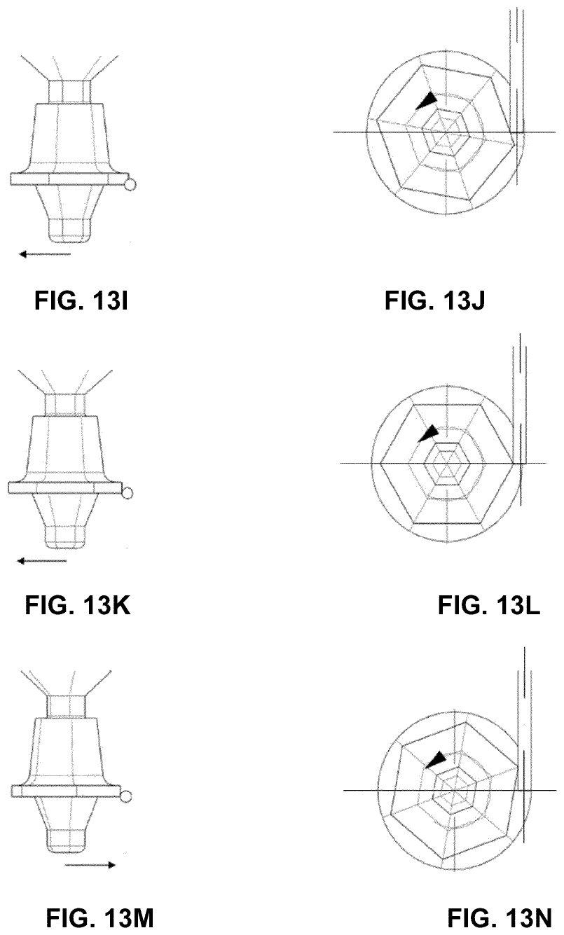

FIGS. 13 and 13A-13N show a second embodiment of laser machining. The second embodiment differs from the first embodiment of FIGS. 1-12 in that the work piece 24 includes an outer work piece shape 21, that is to be generated and that includes flat surfaces. After the laser machining is completed, the work piece 24 has hexagonal cross sections with different size in the machined section. Therefore, the work piece shape to be generated is not rotation symmetrical. This outer work piece shape is generated by a super position of the first movement, namely a rotation of the work piece 24 about the geometrical work piece longitudinal axis 25, the second movement which corresponds to running the laser beam along a laser path between the 2 points A and B, that is predetermined by the external work piece shape 21 to be generated, and a third movement that corresponds to a feed movement in a direction 26. Thus, a beam axis 22a of the laser beam 22 is oriented perpendicular to the work piece plane 28 in which the geometric work piece longitudinal axis 25 runs. The work piece plane is illustrated in FIG. 13B. The two points A and B which represent the boundaries of the work piece contour in the axial direction are offset relative to the geometric work piece longitudinal axis 25 in the axial direction. Additionally the two points A and B are offset in the radial direction.

FIGS. 13A-13N show different stages of material removal in an axial section of the work piece 24 according to FIG. 13 and the associated orientation of the laser beam 22 relative to the work piece 24. The arrows 26 in FIGS. 13C, 13E, 13G, 13I, 13J, 13K and 13M thus show how the third movement designated as the feed movement is coordinated with the first movement designated as a rotation movement, of the work piece 24 about its geometric work piece longitudinal axis 25 and the position of the laser beam 22 along the laser path between the points A and B in order to generate the predetermined edged cross section that is associated with the associated axial section. Thus, the work piece shape 21 can be generated at a circular cylindrical work piece as illustrated in FIG. 1. FIGS. 13B, 13D, 13F, 13H, 13J, 13L and 13N show that the orientation of the laser beam 22 relative to the work piece plane 28 does not change during laser machining.

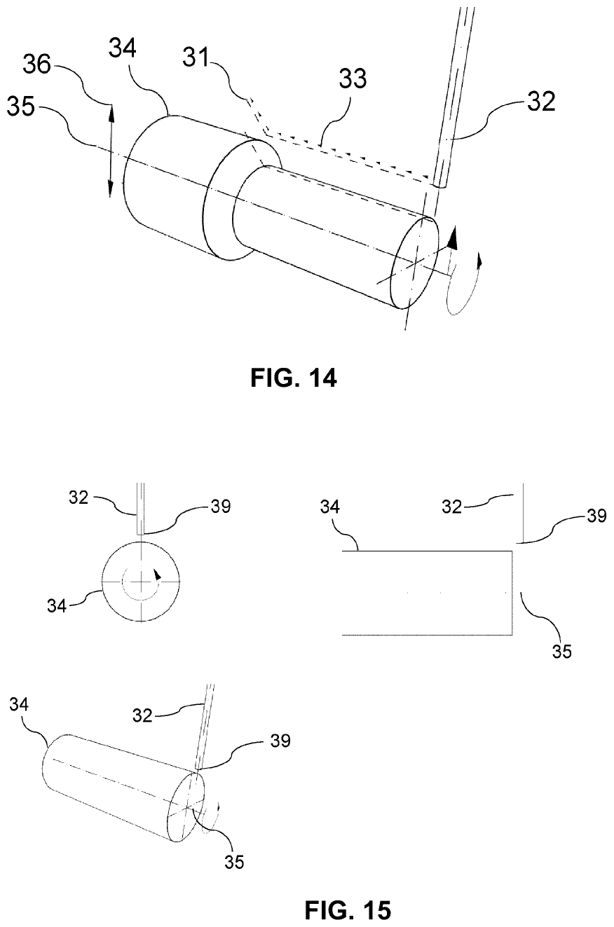

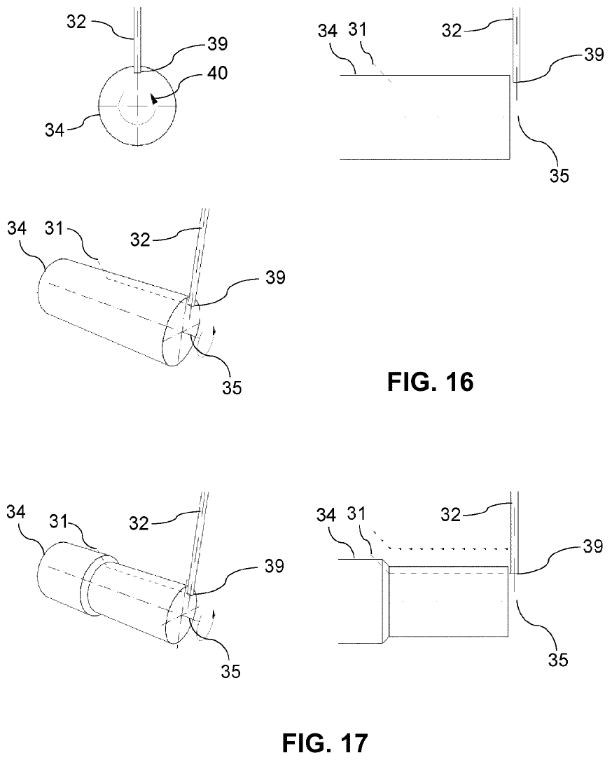

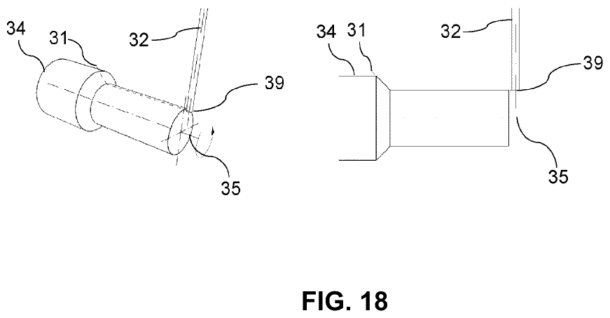

FIGS. 14-18 show an embodiment of laser machining that is not done according to the invention. This embodiment differs from the first embodiment according to FIGS. 1-12 in that a beam axis of the laser beam 32 is oriented radially to the geometric work piece longitudinal axis 35 of the work piece 34 during material removal. The laser beam 32 is run along the laser path 33 that is predetermined by a work piece contour 31 of the work piece 34. The feed movement according to the third movement is performed in the direction 36. FIG. 15 shows the work piece 34 and the laser beam 32 before a beginning of the laser machining. At this point in time the work piece has a shape of a circular cylinder. The laser machining starts in FIG. 16. The feed movement of the third movement moves the work piece 34 towards the laser beam 32, so that the focus 39 of the laser beam is in an area of the work piece contour 31 to be generated. The arrow 40 shows the rotation of the work piece 34 about the work piece longitudinal axis 35 according to the first movement. FIG. 17 shows the work piece 34 after a portion of the material was removed from the outside of the work piece. FIG. 18 shows in the finished work piece at an end of the laser machining.

FIG. 19 shows the laser machining device 50 for performing the method. The laser machining device 50 includes a work piece fixing device 51 that receives and fixes a work piece 54, a movement device 53 that moves the work piece 54 arranged in the fixing device relative to a device base 55, a laser 56 which generates a laser beam 52 and a laser deflection device 57 that guides the laser beam 52. In the instant embodiment the movement device 53 includes three linear axes X, Y, Z. and two rotation axes B and C, thus the rotation axis C causes a rotation of the work piece 54 arranged in the work piece fixing device 51 about a geometric work piece longitudinal axis that runs through the work piece. The laser deflection device 57 moves and guides the laser 52 in three different directions in space, thus the laser beam 52 is moved relative to the work piece 54 along a laser path that is not illustrated. For this purpose the laser deflection device 57 includes plural mirrors which deflect the laser beam in a controlled manner. Additionally the laser deflection device includes at least one lens that focuses the laser beam onto the surface of the work piece 54.

All features can be implemented according to the invention individually or in any number of combinations.

### REFERENCE NUMERALS AND DESIGNATIONS

1 nominal work piece contour
2 laser beam
2a beam axis
3 laser path
4 work piece
5 work piece longitudinal axis
6 movement direction of the work piece during the third movement
7 contact point of laser beam and work piece at a beginning of the laser machining
8 work piece plane
9 laser focus
10 closed curve when moving the laser beam according to the fourth movement
11 open curve when moving the laser beam according to the fourth movement
21 nominal work piece shape
22 laser beam
22a beam axis
24 work piece
25 work piece longitudinal axis
26 direction of feed movement
28 geometric work piece plane
31 nominal work piece contour of the work piece
32 laser beam
33 laser path
34 work piece
35 work piece longitudinal axis
36 direction of feed movement
39 focus of laser beam
40 rotation according to first movement
50 laser machining device
51 work piece fixing device
52 laser beam
53 work piece movement device
54 work piece
55 device base
56 laser
57 laser deflection device.

1. A method for laser machining an elongated workpiece that extends along a geometric workpiece longitudinal axis, the method comprising:
producing a predetermined three-dimensional outer workpiece shape with a workpiece contour at the elongated workpiece by removing material through a laser beam,
wherein the workpiece contour corresponds to an intersection of the predetermined three-dimensional outer workpiece shape with a geometric workpiece plane in which the geometric workpiece longitudinal axis extends,
wherein the workpiece contour extends between a first point A and a second point B, and the first point A and the second point B are offset from one another at least in an axial direction;
using a laser machining device including a workpiece fixing device that fixes the elongated workpiece, a movement device moving the workpiece fixing device relative to a device base, a laser generating a laser beam oriented along a beam axis and including a laser deflection device deflecting the laser beam in a controlled manner;
arranging the elongated workpiece in the workpiece fixing device;
performing three movements including
a first movement that is a workpiece rotation movement where the workpiece fixing device is driven by the workpiece movement device to rotate the elongated workpiece arranged in the workpiece fixing device about the geometric workpiece longitudinal axis in a continuous sequence of complete rotations,
a second movement guiding the laser beam, so that the laser beam is moved along a predetermined laser path by the laser deflection device, wherein the predetermined laser path corresponds to the workpiece contour between the first point A and the second point B,
wherein the laser beam is oriented perpendicular relative to the geometric workpiece plane and encloses on angle of 10 degrees at the most with an orthogonal of the geometric workpiece plane,
wherein the laser beam is run along the laser path between the first point A and the second point B multiple times during the second movement,
a third movement that is a feed movement where the workpiece fixing device and/or the laser beam are advanced so that the surface of the elongated workpiece arranged in the workpiece fixing device contacts the laser beam so that the laser beam is oriented tangential to the surface of the elongated workpiece or encloses an angle of 10 degrees at the most with a tangent to the surface of the elongated workpiece, wherein the laser beam removes material from the surface of the elongated workpiece and generates the predetermined three-dimensional outer workpiece shape with the workpiece contour,
wherein the first movement, the second movement, and the third movement are performed simultaneously and parallel with one another until the predetermined outer workpiece shape with the workpiece contour is generated at the elongated workpiece.

2. The method according to claim 1, wherein the laser beam is run along the laser path from the first point A to the second point B and subsequently from the second point B to the first point A.

3. The method according to claim 1, wherein the laser beam is run along the laser path from the first point A to the second point B perpendicular to the beam axis in the second movement.

4. The method according to claim 1, wherein the first point A and the second point B form boundaries of the predeterminer three dimensional outer work piece shape in the axial direction relative to the geometric work piece longitudinal axis.

5. The method according to claim 1, wherein the laser beam performs an additional fourth movement, where the laser beam is moved about a center in open or closed curves and the fourth movement is superimposed to the second movement.

6. The method according to claim 5, wherein a ratio between a diameter of the open or closed curve and a diameter of the laser beam is between 1.2 and 150 at an impact point of the laser beam at the elongated work piece.

7. The method according to claim 1, wherein the work piece fixing device is moved in a direction perpendicular to the beam axis of the laser beam in the third movement.

8. The method according to claim 1, wherein the laser beam is moved towards the elongated work piece in the third movement.

9. The method according to claim 1, wherein the third movement is a linear movement in a radial direction with reference to the geometric work piece longitudinal axis.

10. The method according to claim 1, wherein the third movement includes a linear movement in the axial direction or parallel to the axial direction with reference to the geometric work piece longitudinal axis.

11. The method according to claim 1, wherein the beam axis of the laser beam is oriented parallel to a radial direction of the geometric work piece longitudinal axis when removing material from the surface of the work piece.

12. The method according to claim 1, wherein the beam axis of the laser beam is inclined relative to a tangent at the surface of the elongated work piece by an angle α in the axial direction, wherein the angle α is between 1 degree and 10 degrees.

13. The method according to claim 1, wherein the third movement is controlled as a function of the second movement.

14. The method according to claim 1, wherein the third movement is controlled as a function of the first movement.

15. The method according to claim 1, wherein material is removed within an axial section between the first point A and the second point B along an entire circumference of the work piece.

16. The method according to claim 1, wherein the work piece rotation movement is performed with constant speed during an entire material removal.

17. A laser machining device configured to perform the method according to claim 1,
the laser machining device comprising:
the workpiece fixing device that receives the elongated workpiece;
the movement device that moves the workpiece fixing device relative to the device base and includes the laser which generates the laser beam oriented along the laser beam axis, and includes the laser deflection device that deflects the laser beam in a controlled manner,
wherein the movement device is configured to perform the first movement that is the workpiece rotation movement where the workpiece fixing device rotates the elongated workpiece arranged in the workpiece fixing device about the geometric workpiece longitudinal axis in a continuous sequence of complete rotations,
wherein the laser deflection device is configured to perform the second movement guiding the laser beam, so that the laser beam is moved along the predetermined laser path, wherein the predetermined laser path extends from the first point A to the second point B, and wherein the laser path is defined by the workpiece contour of the three dimensional outer workpiece shape,
wherein the workpiece movement device and/or the laser are configured to perform a feed movement as a third movement, so that the surface of the elongated workpiece arranged in the workpiece fixing device contacts the laser beam, wherein the laser beam removes material from the surface of the elongated workpiece and generates the predetermined three-dimensional outer workpiece shape with the outer workpiece contour, and
wherein the first movement, the second movement and the third movement are performed simultaneously, and
wherein the laser machining device includes a control device which controls the first movement, the second movement and the third movement.
